(19) United States
(12) Patent Application Publication
(10) Pub. No.: US 2018/0357557 A1
(43) Pub. Date: Dec. 13, 2018

(54) IDENTIFICATION OF DECISION BIAS WITH ARTIFICIAL INTELLIGENCE PROGRAM

(71) Applicant: MICROSOFT TECHNOLOGY LICENSING, LLC, REDMOND, WA (US)

(72) Inventors: EMMA MARY WILLIAMS, MEDINA, WA (US); NEAL T. OSOTIO, SAMMAMISH, WA (US)

(21) Appl. No.: 15/617,795

(22) Filed: Jun. 8, 2017

(51) Int. Cl. G06N 99/00

(52) U.S. Cl. CPC G06N 99/005; G06F 3/0481

(57) ABSTRACT

Methods, systems, and computer programs are presented for notifying users of identified bias when the users make decisions. One method includes an operation for tracking, by a bias machine-learning program (MLP), the activities of a user. A set of features is defined for detecting bias, where the features include user profile information, user environment information, history of activities and decisions of the user, community information, and a knowledge base that includes facts. Additionally, the bias MLP detects a decision of the user based on the tracked activities, and analyzes the decision for bias when making the decision. The analysis is based on the decision, facts relevant to making the decision, and the features utilized by the bias MLP. When a bias is detected, a notification is presented to the user of the detection of the bias, with one or more reasons for the detected bias.

### TECHNICAL FIELD

The subject matter disclosed herein generally relates to methods, systems, and programs for providing useful information to assist in decision making.

### BACKGROUND

The human brain produces more than 50,000 thoughts each day, and given the large processing power of human brains, it would be reasonable to assume that most human decisions would be optimal decisions, or close to optimal. However, experience tells us that many times humans make the wrong decisions based on different factors, such as environment, greed, misconceptions, incorrect knowledge of facts, bias, and so forth. Cognitive bias is the tendency to make wrong judgments based on pertinent facts.

Computer assistants are growing in popularity by helping users with everyday tasks, including gathering information. Computer assistants are also increasingly helping users with decision making, such as by providing fashion tips, trends, and so forth. But sometimes, humans make the wrong decisions, and many times they find out too late that the decisions are wrong. Also, when humans make the wrong decisions, computer assistants have to deal with uncertainty and irrationality because if the computer assistant learns from the user's decisions, then the computer assistants are learning based on wrong decisions.

### BRIEF DESCRIPTION OF THE DRAWINGS

Various ones of the appended drawings merely illustrate example embodiments of the present disclosure and cannot be considered as limiting its scope.

FIG. 1 illustrates a system for implementing embodiments.

FIG. 2 is a block diagram illustrating a networked system, according to some example embodiments.

FIG. 3 illustrates the tracking of user activities for detecting bias, according to some example embodiments.

FIG. 4 illustrates an example for detecting bias when the user is engaged in a planning activity, according to some example embodiments.

FIG. 5 is a flowchart of a method, according to some example embodiments, for detecting bias.

FIG. 6 illustrates bias detection when the user makes a decision, according to some example embodiments.

FIG. 7 illustrates the training and use of a machine-learning program, according to some example embodiments.

FIG. 8 shows the feature set utilized for the bias machine-learning program, according to some example embodiments

FIG. 9 is a flowchart of a method, according to some example embodiments, for notifying users of identified bias when the users make decisions.

FIG. 10 is a block diagram illustrating an example of a machine upon which one or more example embodiments may be implemented.

### DETAILED DESCRIPTION

Example methods, systems, and computer programs are directed to notifying users of identified bias when the users make decisions. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Embodiments presented herein provide for ways to utilize artificial intelligence and machine learning to understand and analyze how decisions are made. User activities are tracked (according to the user's privacy settings), a bias machine-learning program (MLP) detects when the user is making a decision or when the decision has been made, and the bias MLP analyzes if the decision is the best decision in view of the facts involved. This way, a computer assistant may work with the user to help increase trust, engagement, connection, and collaboration with the computer assistant.

The computer assistant gathers information of the user, such as profile data, activities, previous decisions, and so forth, to engage the bias MLP for assisting the user during decision making. For example, if the user is developing a schedule for a project, the computer assistant may point out to the user that the testing phase was underestimated in the last three project plans created by the user. Recognizing and understanding bias is very valuable for a user because it allows the user to think more objectively and to interact more effectively with other people.

Previous solutions to bias detection are based on reactive learning, self help books, and information gathering by the user. But these solutions are not aware of the user context, such as past history, abilities, group settings, and the like, to analyze the environment for making decisions. Further, these previous solutions are not able to notify the user that the user may be influenced by a bias when making an actual decision, and the user herself has to determine when a bias may be influencing a decision.

One general aspect includes a method including: tracking, by a bias MLP executed by one or more processors, activities of a user interfacing with a computing device, the bias MLP defining a plurality of features for detecting bias, the plurality of features including user profile information, user environment information, history of activities and decisions of the user, community information, and a knowledge base that includes facts. The method also includes detecting, by the bias MLP, a decision made by the user based on the tracked activities. The method also includes analyzing, by the bias MLP, the decision for bias by the user when making the decision, the analysis based on the decision, facts relevant to making the decision, and features utilized by the bias MLP. The method also includes causing notification to the user of the detection of the bias when a bias is detected, the notification including one or more reasons for the detected bias.

One general aspect includes a system including a memory having instructions and one or more computer processors. The instructions, when executed by the one or more computer processors, cause the one or more computer processors to perform operations including: tracking, by a bias MLP, activities of a user interfacing with a computing device, with the bias MLP defining a plurality of features for detecting bias, and the plurality of features including user profile information, user environment information, history of activities and decisions of the user, community information, and a knowledge base that includes facts; detecting, by the bias MLP, a decision made by the user based on the tracked activities; analyzing, by the bias MLP, the decision for bias by the user when making the decision, the analysis based on the decision, facts relevant to making the decision, and features utilized by the bias MLP; and, when a bias is detected, causing notification to the user of the detection of the bias, the notification including one or more reasons for the detected bias.

One general aspect includes a non-transitory machine-readable storage medium including instructions that, when executed by a machine, cause the machine to perform operations including: tracking, by a bias MLP, activities of a user interfacing with a computing device, the bias MLP defining a plurality of features for detecting bias, with the plurality of features including user profile information, user environment information, history of activities and decisions of the user, community information, and a knowledge base that includes facts; detecting, by the bias MLP, a decision made by the user based on the tracked activities; analyzing, by the bias MLP, the decision for bias by the user when making the decision, the analysis based on the decision, facts relevant to making the decision, and features utilized by the bias MLP; and, when a bias is detected, causing notification to the user of the detection of the bias, the notification including one or more reasons for the detected bias.

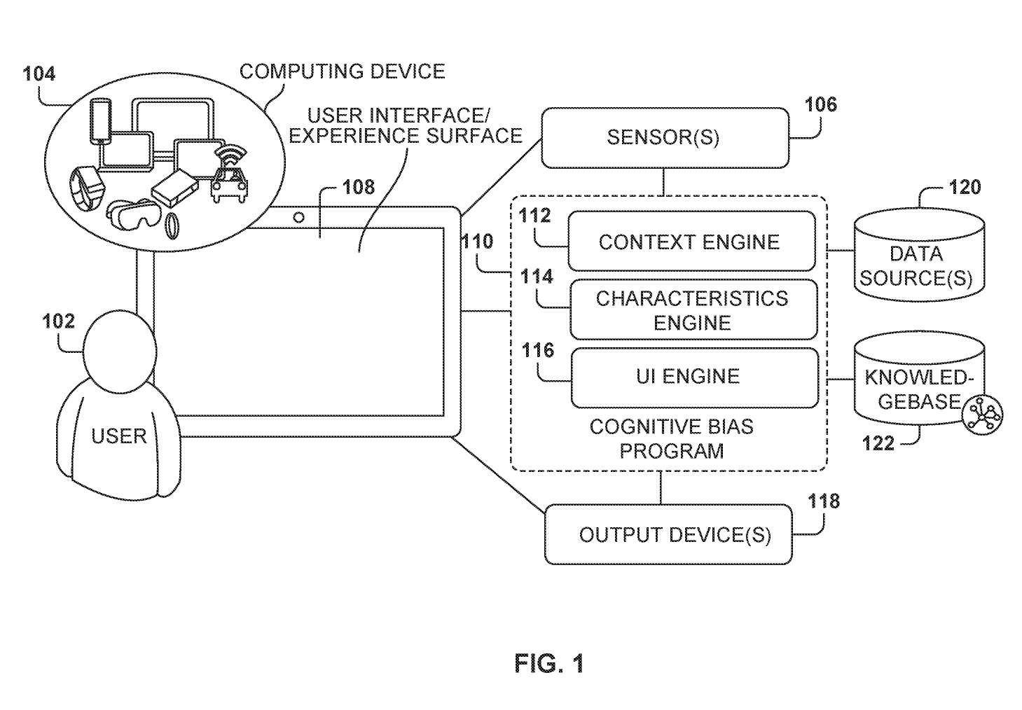

FIG. 1 illustrates a system for implementing embodiments. The block diagram shows an example operating environment including components of a cognitive bias system for generating an electronic response related to the user's characteristics and context.

Bias has been defined as a particular tendency, trend, inclination, feeling, or opinion, especially one that is preconceived or unreasoned. Bias has also been defined as an unreasonable hostile feeling or opinion towards a person or group. As used herein, bias, when making a decision, refers to a belief held by a user that creates an obstacle for reaching the best decision in view of the relevant facts. It is not the goal of the bias MLP described below to criticize the user. The goal of the bias MLP is to notify the user when a decision made may not be the optimal decision because of a bias, in view of an analysis of the facts involved when making the decision.

For example, if a child uses a computer assistant, the child may have a bias against using sophisticated language because of her age. Therefore, the computer assistant may look for simpler language to communicate with the child.

Multiple types of biases have been identified over time, such as the decoy effect (someone believes there are only two options, but there are more options), the affect heuristic (tendency to base decisions on emotions), the fundamental attribution error (tendency to attribute situational behavior to a person's fixed personality), the confirmation bias (tendency to seek out information that supports pre-existing beliefs), the conservatism bias (believe that pre-existing information takes precedence over new information), and others.

Providing the ability, through artificial intelligence and machine learning, to determine that a decision may be biased and notify the decision maker is very valuable to the decision maker in order to improve the way decisions are made. This understanding helps the user to increase trust, engagement, connection, and collaboration with others and with the computer assistant that provides the bias notification.

With reference to FIG. 1, a user 102 interacts with a computing device 104 to access the cognitive bias program 110, also referred to herein as the bias MLP, which may be part of a personal computer assistant. The computing device 104 may be any type of computer device with communications capabilities, such as a desktop machine, a laptop, a tablet, a smart phone, a smart watch, a fitness tracking device, virtual reality glasses, and so forth. The computing device 104 includes a user interface 108 for presenting information from the computer assistant. In addition, the computing device 104 may include, or be connected to, one or more sensors 106 that provide information about the user or the environment, and one or more output devices 118.

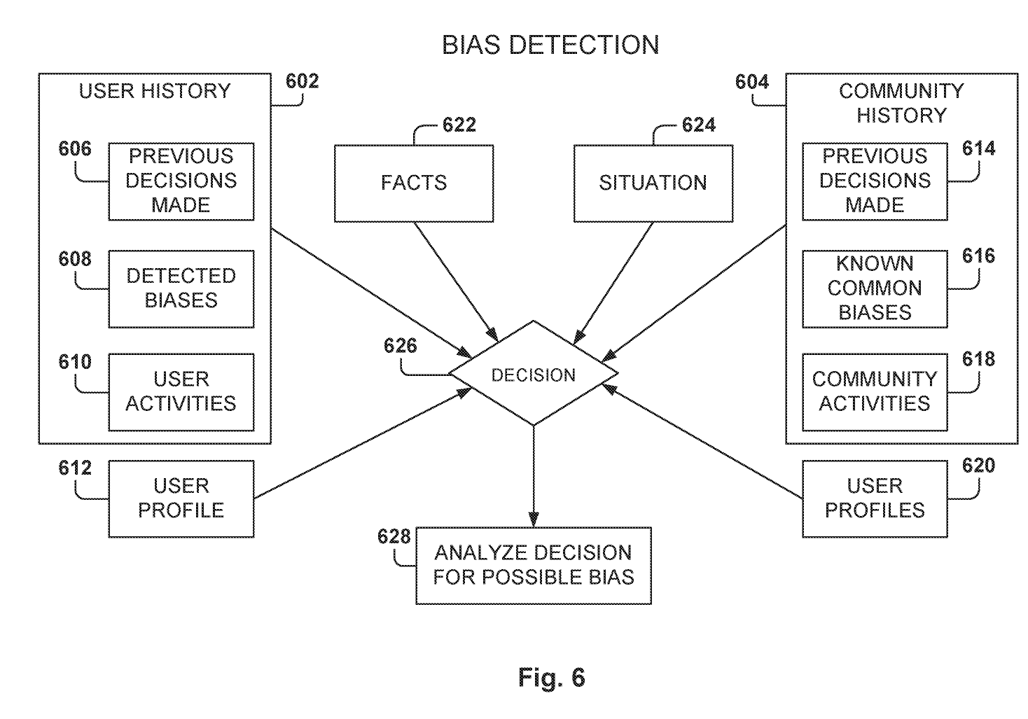

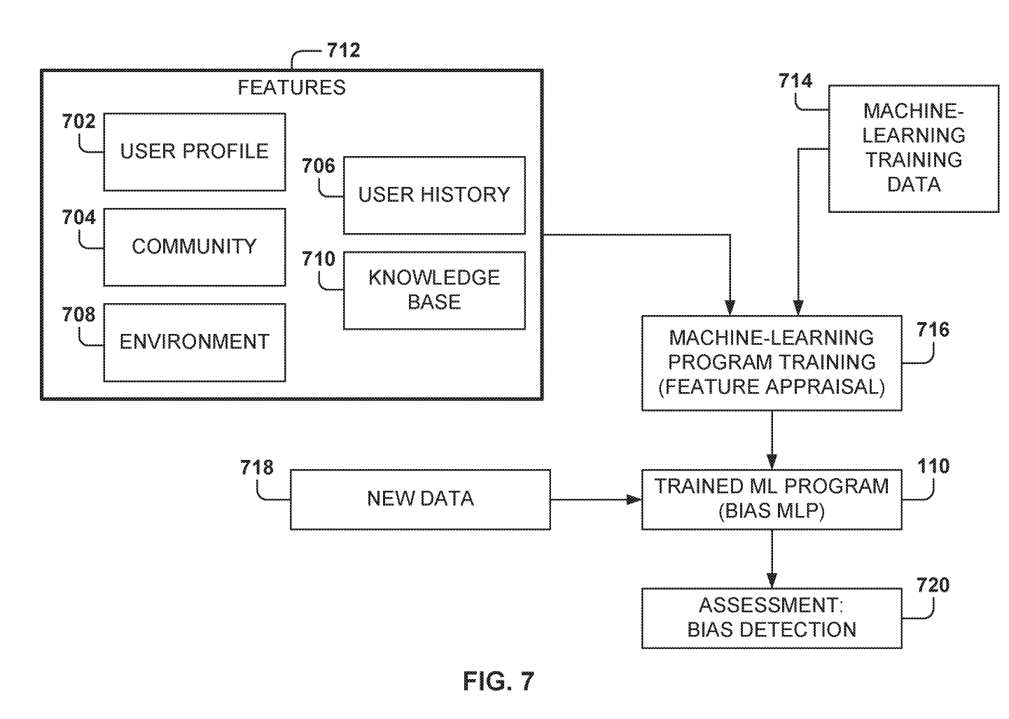

The bias MLP 110 includes a context engine 112, a characteristics engine 114, and a user interface (UI) engine 116, and the bias MLP 110 may be connected to one or more data sources 120 and a knowledge base 122. The context engine 112 analyzes the context of the interactions with the user 102, such as an ongoing conversation, activities of the user 102, team activities related to the user, and so forth. The characteristics engine 114 identifies the relevant characteristics, also referred to herein as features, for the user interactions. The UI engine 116 communicates with the computing device 104 for presenting the user interface 108. The knowledge base 122 includes a variety of information gathered by the system related to the user, as described below with reference to FIGS. 6-7.

The present disclosure recognizes that the use of personal information data, in the present technology, can be used to the benefit of users. For example, the personal information data may be used to deliver content that is of interest to the user or to provide tailored services for the user. Accordingly, use of such personal information data enables calculated control of the delivered content and services. The personal information may include data describing the user (e.g., name, address, education), sensor data about the user captured by sensors (e.g., heart rate, location, exercise data), social data related to user connections of the user on one or more social networks or by service providers, and activities performed by the user (e.g., shopping, browsing, searching, news reading, researching).

The present disclosure further contemplates that the entities responsible for the collection, analysis, disclosure, transfer, storage, or other use of such personal information data comply with well-established privacy policies and/or privacy practices. In particular, such entities implement and consistently use privacy policies and practices that are generally recognized as meeting or exceeding industry or governmental requirements for keeping personal information data private and secure. Additionally, such entities take needed steps for safeguarding and securing access to such personal information data and ensuring that others with access to the personal information data adhere to their privacy policies and procedures.

Despite the foregoing, the present disclosure contemplates embodiments in which users may selectively block the collection and/or use of personal information. That is, the present disclosure contemplates that hardware and/or software elements can be provided to block access to such personal information data. For example, in the case of service delivery, the present technology can be configured to allow users to select to “opt in” or “opt out” of participation in the collection or use of personal information during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content and services may be delivered to users by inferring preferences based on non-personal information data, a subset of the personal information, the device used by the user, community information, other non-personal information, or publically-available information.

For example, in the case of bias detection, if the user opts out from collecting personal activity data, the computer assistant may still provide suggestions based on other personal data enabled for use as well as available community data (e.g., data collected for other users).

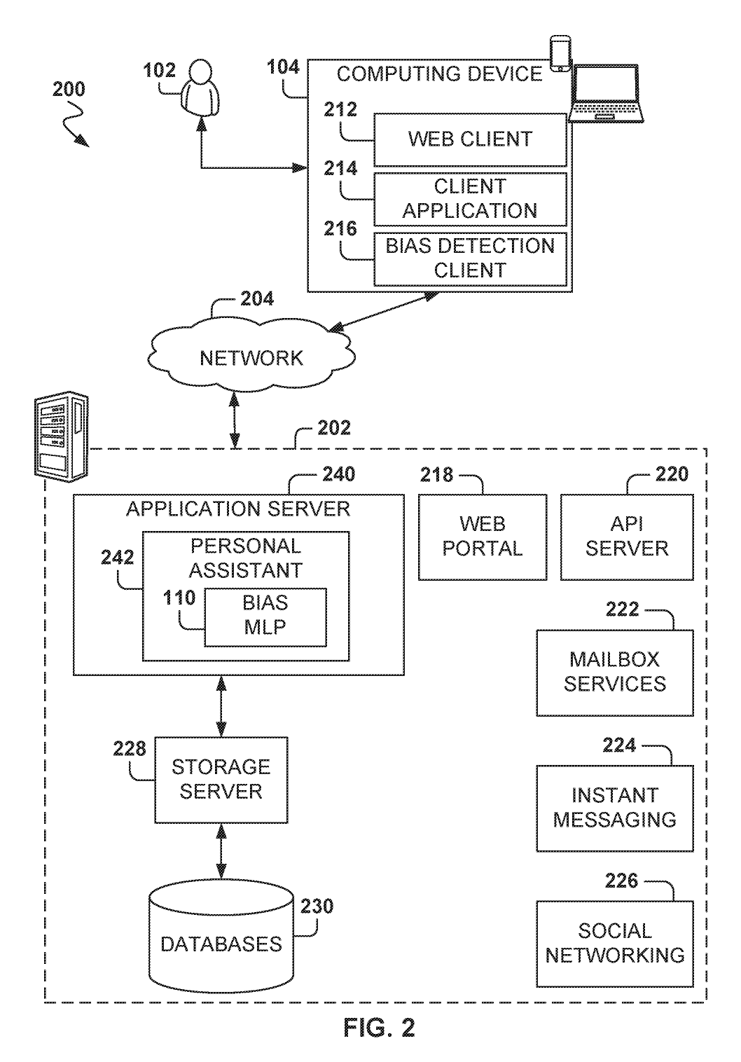

FIG. 2 is a block diagram illustrating a networked system, according to some example embodiments. An example embodiment of a high-level client-server-based network architecture 200 is shown. A networked system 202, in the example form of a network-based service-delivery system, provides server-side functionality via a network 204 (e.g., the Internet) to one or more computing devices 104, such as a web client 212 (e.g., a browser), a client application 214, and a bias detection client 216 executing on computing device 104.

The computing device 104 may comprise, but is not limited to, a mobile phone, desktop computer, laptop, portable digital assistant (PDA), smart phone, tablet, ultra book, netbook, laptop, multi-processor system, microprocessor-based or programmable consumer electronics, game console, set-top box (STB), or any other communication device that a user may utilize to access the networked system 202. In some embodiments, the computing device 104 may comprise a display module (not shown) to display information (e.g., in the form of user interfaces). In further embodiments, the computing device 104 may comprise one or more touch screens, accelerometers, gyroscopes, cameras, microphones, global positioning system (GPS) devices, and so forth.

In one embodiment, the networked system 202 is a network-based service that provides a service for a personal computer assistant, which may be embedded or bundled with other programs, such as an operating system or a web browser. The networked system 202 includes an application server 240, a storage server 228, databases 230, a web portal 218, an application program interface (API) server 220, mailbox services 222, instant messaging 224, and social networking 226.

Each of the computing devices 104 may include one or more applications (also referred to as “apps”) such as, but not limited to, a web browser, messaging application, a personal assistant, electronic mail (email) application, an e-commerce site application (also referred to as a marketplace application), and the like. In some embodiments, if the personal-assistant application is included in a given one of the computing devices 104, then this application is configured to locally provide the user interface and at least some of the functionalities with the application configured to communicate with the networked system 202, on an as needed basis, for data and/or processing capabilities not locally available.

The API server 220 and the web portal 218 are coupled to, and provide programmatic and web interfaces respectively to, one or more application servers 240. The application servers 240 may host a personal assistant 242, which includes a bias MLP 110. The application servers 240 are, in turn, shown to be coupled to one or more storage servers 228 that facilitate access to one or more information storage repositories or database(s) 230. In an example embodiment, the databases 230 are storage devices that store information about the user and/or about the community, and a knowledge database storing facts.

In addition, mailbox services 222 provide communications capabilities for the users, such as email services. The instant messaging 224 provides instant message capabilities for the users of the service, and the social networking program 226 provides a social network to the users 102.

Further, while the client-server-based network architecture 200 shown in FIG. 2 employs a client-server architecture, the present inventive subject matter is of course not limited to such an architecture, and could equally well find application in a distributed, or peer-to-peer, architecture system, for example.

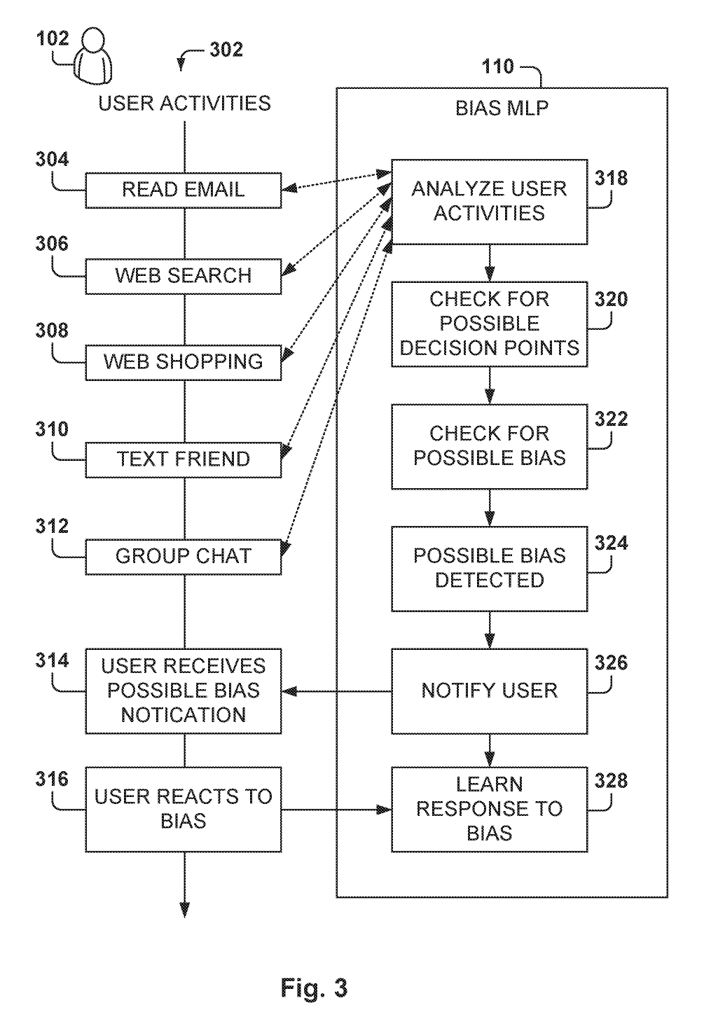

FIG. 3 illustrates the tracking of user activities for detecting bias, according to some example embodiments. FIG. 3 illustrates an example of bias detection when using a personal computer assistant, which includes the bias MLP 110. The user 102 interacts with the bias MLP 110, and user activities 302 are tracked and analyzed 318 by the bias MLP 110.

The user activities 302 may include any combination of reading email 304, performing web searches 306, shopping online 308, communications with friends 310 (e.g., texting and messaging), chat activities within a group environment 312, and so forth.

The bias MLP 110 checks for possible decision points at operation 320, based on the user activities analyzed 318. The decision points are those moments in time when the user 102 makes a decision. A decision, as used herein, refers to an act by the user to make up her mind about something. In many cases, the decision involves taking a course of action from several possibilities, such as scheduling a meeting, estimating the duration of a task, selecting a candidate for a job offer, purchasing an item, making a phone call, sending a communication, and so forth.

Once the decision point is identified, a check is made at operation 322 for a possible bias when making the decision. As described above, bias refers to a belief held by the user that creates an obstacle for reaching the best decision. If a possible bias is detected at operation 324, the bias MLP 110 notifies the user that bias may have influenced the decision.

In some example embodiments, the bias MLP may also identify a potential bias even before the user makes a decision. For example, the bias MLP may identify that the user is contemplating one of two available options, but there may be more than two options available to the user. The bias MLP may then notify 326 the user of the existence of additional options.

At operation 314, the user receives the notification for a possible bias, which includes the decision made and the identified bias. In some example embodiments, a reason for the detected bias is also included in the notification. In some cases, a recommendation may also be included with the notification, such as proposing an alternate decision. For example, the notification may suggest the user book a different flight, buy an alternate product, allocate more time to a task, and so forth.

At operation 316, the user reacts to the bias, such as by agreeing with the bias MLP 110 to take a different course of action, by dismissing the recommendation, by stating that further consideration is required, or the like. The reaction from the user is identified by the bias MLP 110 in order to continue learning 328 from users' reactions to bias. For example, the new information from the user may be used for future training of the bias MLP 110 for detecting bias.

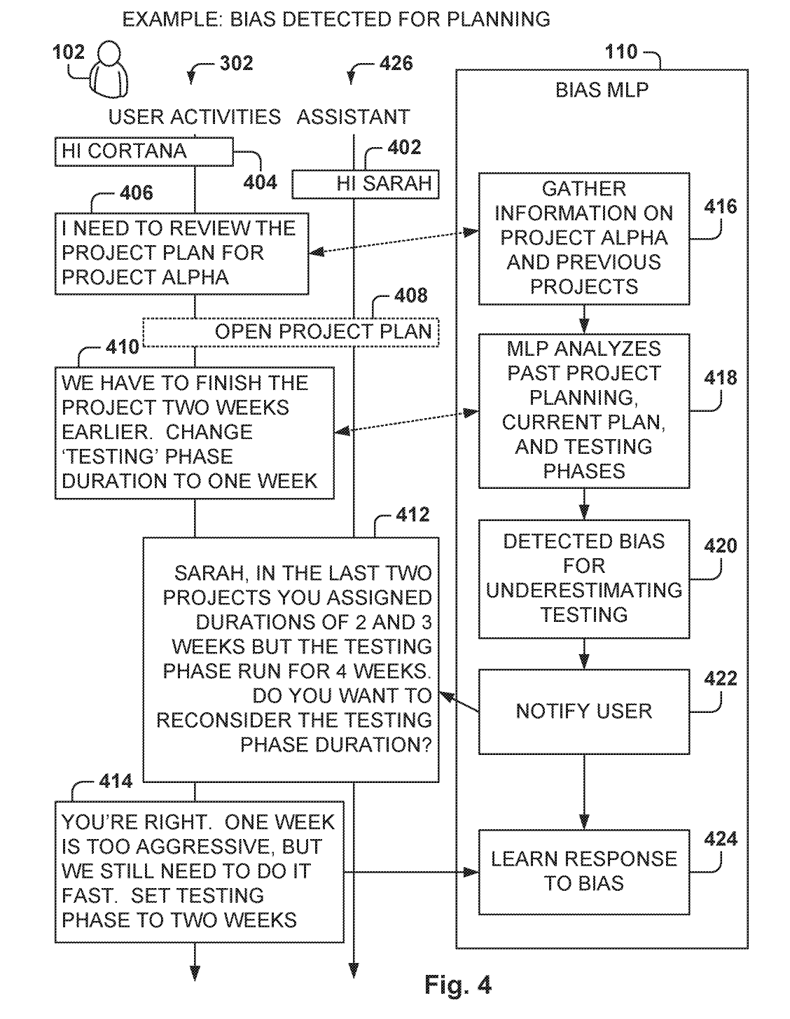

FIG. 4 illustrates an example for detecting bias when the user is engaged in a planning activity, according to some example embodiments. The example of FIG. 4 includes the user activities 302, computer personal assistant 426 activities, and the activities of the bias MLP 110.

At operations 404 and 402, the user 102 exchanges salutations with the personal assistant 426. At operation 406, the user 102 enters a request for the personal assistant 426, the request stating, “I need to review the project plan for project Alpha.”

In response to the request, at operation 416, the bias MLP 110 gathers information on project Alpha and information about previous projects. Additionally, the personal assistant 426 may open the project plan at operation 408 on the user interface of the user 102.

The user 102 continues the dialogue with the personal assistant 426, and at operation 410, the user states. “We have to finish the project two weeks earlier. Change ‘testing’ phase duration to one week.” In response to the user assertion, the bias MLP 110 analyzes previous project planning activities of the user, the current plan for project Alpha, the duration of the testing phases of the identified projects, and other data relevant to the user.

Based on the analysis at operation 418, at operation 420, the bias MLP 110 detects a bias by the user in underestimating the testing-phase duration. From operation 420, the method flows to operation 422, where the bias MLP 110, via the personal assistant 426, notifies the user. As a result, in operation 412, the personal assistant 426 provides the following message for the user, “Sarah, in the last two projects you assigned durations of 2 and 3 weeks but the testing phase run for 4 weeks. Do you want to reconsider the testing phase duration?”

At operation 414, the user 102 responds to the bias notification. “You're right. One week is too aggressive, but we still need to do it fast. Set testing phase to 2 weeks.” The bias MLP 110 learns from the response of the notification by the user at operation 424. In this case, the feedback is positive because the user agreed with the recommendation to change the duration.

FIG. 4 illustrates an example for project planning, but the bias detection may be applied in many other scenarios, such as when the user is shopping (to optimize purchase decisions), when the user is traveling (to select the best fare, hotel destination, etc.), when the user is in a negotiation with others (e.g., to suggest negotiation tactics), when the user is buying food (e.g., to buy better or healthier products), and so forth.

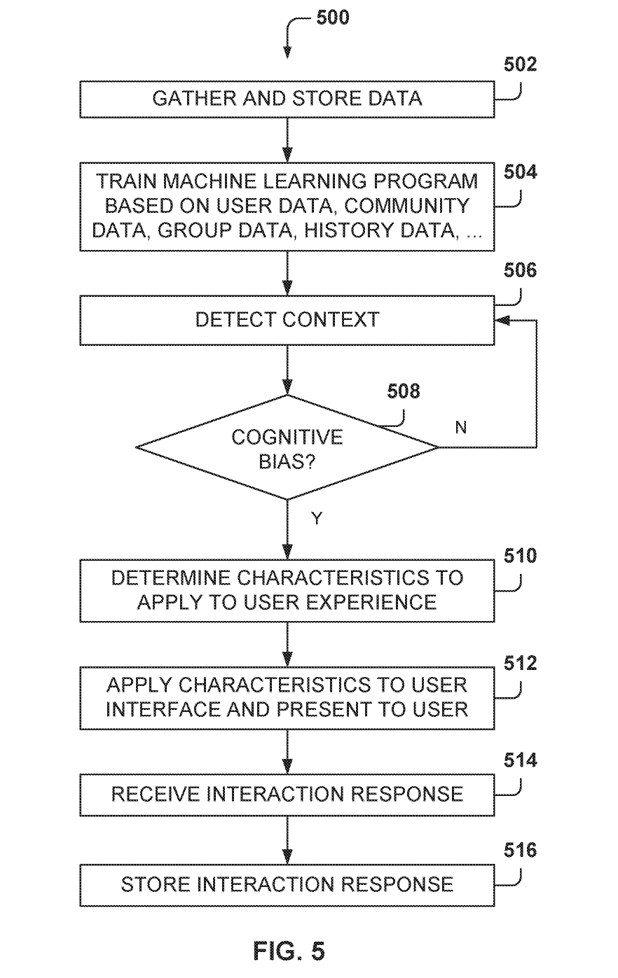

FIG. 5 is a flowchart of a method 500, according to some example embodiments, for detecting bias. While the various operations in this flowchart are presented and described sequentially, one of ordinary skill will appreciate that some or all of the operations may be executed in a different order, be combined or omitted, or be executed in parallel.

At operation 502, the bias MLP gathers and stores data, working together with the personal assistant. As the data is collected, one function of the bias MLP is to determine patterns within the data in order to get information on how people react to the environment and how people make decisions based on relevant facts. This way, patterns of behavior associated with bias are detected.

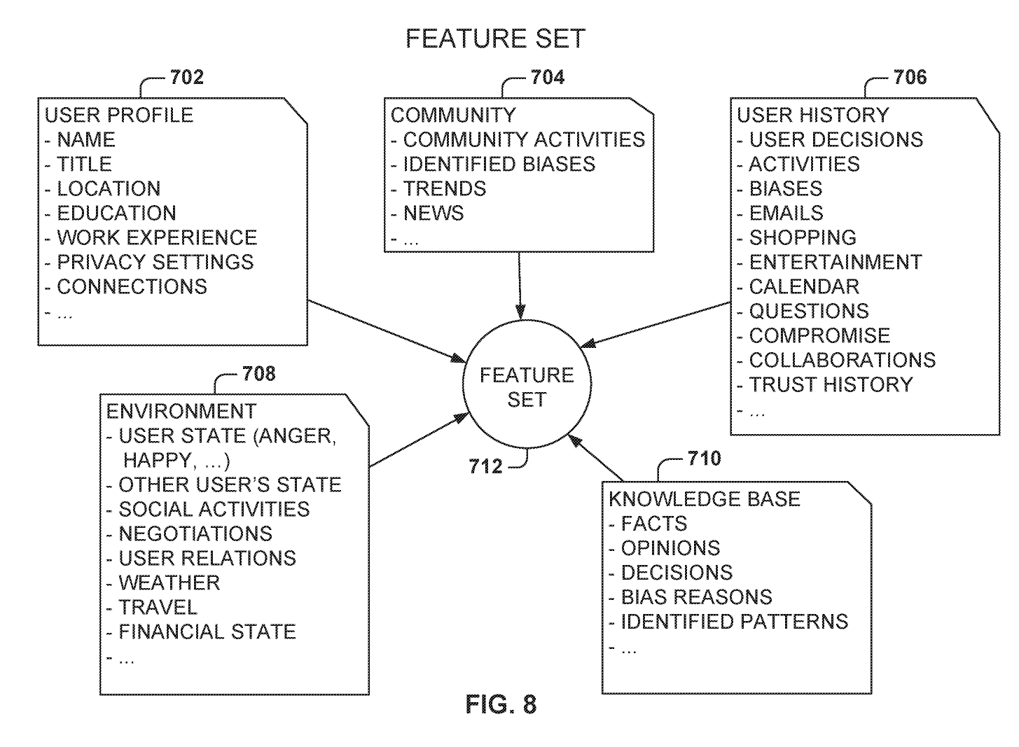

From operation 502, the method flows to operation 504, where the bias MLP is trained based on the user data, community data (e.g., data associated with other users), group data (e.g., data associated with members of a team that the user belongs to), history data (e.g., past activities of the user), and so forth. More details are provided below with reference to FIGS. 7 and 8 regarding the training of the bias MLP.

At operation 506, the context of the user is identified, where the context includes information about the activity being performed by the user and the framework for making a decision. The framework includes facts and decision points, where the facts may be used to determine the best decision for the best possible outcome. In some example embodiments, the decision may be targeted towards the best possible outcome, but in some cases, decisions that are not optimal may also be considered appropriate if the decisions still produce a positive outcome for the user, especially in consideration with factors that may condition a course of action for making the optimal position.

For example, the user may be working on a sales presentation for an important client. The context may identify factors about the relationship between the user and the client, the user's company and the client, and the like. If the bias MLP has information about the client, this information about the client may be used, in addition to the information about the user, to determine a best, or at least a good, decision that will lead to a successful presentation. By understanding the recipient of the presentation, the bias MLP may provide suggestions to the user when the user is working on the sales pitch.

From operation 506, the method flows to operation 508 where a check is made to determine if the cognitive bias has been detected. In some example embodiments, the check includes determining if a bias score provided by the bias MLP is above a predetermined threshold. If the bias score is above the predetermined threshold, the decision is considered to have been biased. If the bias score is not above the predetermined threshold, then the decision is considered to be unbiased. The bias score is a number provided by the bias MLP when the analysis of the decision is made. In some example embodiments, the bias score may be in the range from 0 to 1, or in the range from 0 to 100, or in some other range.

If the check for cognitive bias indicates that a bias was detected, the method flows to operation 510. If the check for cognitive bias indicates that the bias was not detected, the method flows back to operation 506 to continue searching for possible bias when making a decision.

At operation 510, the bias MLP determines the desired characteristics, also referred to herein as features, that are relevant to the user experience. At operation 512, the characteristics are applied to the machine-learning model and the results are presented to the user. This may include the presentation of facts to the user relevant to the decision, where the facts may be related to the user or may relate to known scientific and historical facts.

For example, a user may have a bias against making a reservation at a certain hotel chain because the user had a bad experience in the past in one of the hotels from the chain. If the bias MLP identifies this bias against this particular hotel chain, the bias MLP may introduce facts that might persuade the user to make a reservation at a hotel from the chain. For example, the bias MLP may provide information regarding reviews from other users, special deals at the hotel chain where a good price may get a very good room, a renovation made at the hotel recently, proximity of the hotel to the airport or a meeting place for the user, and the like. The user may analyze the additional facts provided by the personal assistant and consider whether to make a reservation at the hotel chain.

At operation 514, the interaction response is received from the user, and at operation 516, the response information is stored for future analysis and training of the bias MLP. This way, the bias MLP is constantly improving based on the feedback received from users.

FIG. 6 illustrates bias detection when the user makes a decision, according to some example embodiments. Bias detection utilizes user history data 602, user profile data 612, community history data 604, and community user profiles 620. The user history data 602 includes previous decisions made by the user 606, previously detected biases of the user 608, and user activities 610. The community history data 604 includes previous decisions made by the community 614, known common biases on the community 616, and community activities 618. The user profile data 612 includes information about the user, such as name, age, gender, education, birthplace, address, job title, social connections, and the like.

The previous decisions made by the user 606 provide a historical background of the decision-making of the user, which is analyzed to determine patterns of decision making. Further, the previous decisions made by the user 606 are analyzed against their respective outcomes in order to do a post-facto analysis of the value of the decisions. For example, the bias MLP may determine that the user has underestimated the duration of the testing phase of a project, as illustrated above with reference to FIG. 4. Further, the post-facto analysis helps determine the detected biases of the user 608, and the known common biases of the community 616 (which includes the biases detected for the users in the community).

The user activities 610 include the different activities of the user when interacting with the personal assistant or with other services, such as services provided over the Internet. The user activities will 610 may include shopping, work documents, user communications with other users, social posts, blogs, and so forth. In addition, the user activities 610 may include activities of the user framed within activities of the group, and the bias MLP may also be utilized to detect bias on decisions made by the group. The same principles presented herein for detecting bias on an individual may be utilized to detect bias on the decisions made by the group.

Similarly, the previous decisions made 614, the common known biases 616, and the community activities 618, are collected and identified based on the information from the users in the community.

Facts 622 include the facts relevant to making a decision. As used herein, a fact is relevant if knowledge of the fact by the decision maker would influence the decision maker in the final outcome of making the decision. Situation 624 includes the context or environment surrounding the decision, such as a work situation, a personal situation, a decision made in the community, and so forth.

The goal of the bias MLP is to help users make better decisions 626 that are based on the facts 622 and the situation 624. The decision 626 is based on the different elements previously described in reference to FIG. 6. Once the decision is made, the bias MLP analyzes the decision for possible bias 628, as described above.

Because of the different factors involved in making a decision, different users may come up with different decisions under similar circumstances, or two users may come up to the same decision, and one decision may be considered biased while the other decision may be unbiased. For example, with reference to the example of FIG. 4, the bias MLP identifies the decision of assigning one week to testing to be biased based on past behavior of the user. However, if another user has a history of accurate prediction of the testing phase, a decision of a one-week testing phase for that user may not be considered biased. That is, bias is determined, at least, based on the individual.

FIG. 7 illustrates the training and use of a machine-learning program, according to some example embodiments. In some example embodiments, machine-learning programs, also referred to as machine-learning algorithms or tools, are utilized to perform operations associated with identifying bias.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 714 in order to make data-driven predictions or decisions expressed as outputs or assessments 720. Although example embodiments are presented with respect to a few machine-learning tools, the principles presented herein may be applied to other machine-learning tools.

In some example embodiments, different machine-learning tools may be used. For example, Logistic Regression (LR), Naive-Bayes. Random Forest (RF), neural networks (NN), matrix factorization, and Support Vector Machines (SVM) tools may be used for generating training recommendations.

There are multiple types of problems addressed by machine learning, such as classification problems, regression problems, pattern recognition, clustering, dimensionality reduction, and so forth. Classification problems aim at classifying items into one of several categories (for example, is this object an apple or an orange?). Regression algorithms aim at quantifying some items (for example, by providing a value that is a real number). In some embodiments, example machine-learning algorithms provide a bias score (e.g., a number from 1 to 100) for determining if a decision is influenced by bias. In other example embodiments, the machine-learning algorithms provide a classification indicating if a decision was biased or not.

The machine-learning algorithms utilize features for analyzing the data to generate assessments 720. A feature is an individual measurable property of a phenomenon being observed. The concept of feature is related to that of an explanatory variable used in statistical techniques such as linear regression. Choosing informative, discriminating, and independent features is an important operation for effective operation of the MLP in pattern recognition, classification, and regression. Features may be of different types, such as numeric, strings, and graphs.

In one example embodiment, features 712 may be of different types and may be associated with one or more of a user profile 702, community 704, user history 706, environment 708, and knowledge base 710. More details about the features utilized by the MLP are provided below with reference to FIG. 8.

The machine-learning algorithms utilize the training data 714 to find correlations among the identified features 712 that affect the outcome. In some example embodiments, the training data includes known data for one or more identified features and one or more outcomes, such as a bias score associated with a decision indicating if the decision was biased. The outcomes may be identified by human judges that analyze a set of decisions and indicate if the decision was biased. Additionally, the system may learn over time from previous outcomes by learning from the feedback of users themselves that indicate if they agree with an indication by the bias MLP that a decision was biased. In some example embodiments, a probability may be associated with a decision indicating if the decision was biased. For example, it may be determined that a decision was biased with a 90% probability.

With the training data 714 and the identified features 712, the machine-learning tool is trained at operation 716. The machine-learning tool appraises the value of the features 712 as they correlate to the training data 714. The result of the training is the trained machine-learning program 110 (e.g., the bias MLP).

When the trained MLP 110 is used to provide training recommendations, new data 718 is provided as an input to the trained MLP 110, and the trained MLP 110 generates the assessment 720 as output (e.g., the bias score). For example, when a member makes a decision, the bias MLP generates a bias score, indicating the probability that the decision was biased.

Over time, the bias MLP learns more about the patterns associated with bias and it improves the scoring of decisions for bias. In some cases, some patterns may be unknown to the bias MLP, and decisions may be identified as bias, but as the bias MLP learns from experience, new bias patterns may be identified to improve information provided to users regarding possible bias. In some example embodiments, the bias MLP may ask the user for an opinion regarding if the decision was made as biased or unbiased. This way, the bias MLP may continue learning from user interactions.

FIG. 8 shows the feature set utilized for the bias machine-learning program, according to some example embodiments. The feature 712 set includes the user profile features 702, community features 704, user history features 706, environment features 708, and knowledge base features 710. In some example embodiments, additional features may be included, such as data sources, fact checking sources, ratings of products and services, and so forth.

The user profile features 702 include information captured in the profile of the user, such as a name, job title, location where the user recites, location where the user works, education of the user (e.g., degrees and diplomas), work experience of the user (including the places where the user has worked or is currently working), privacy settings (e.g., type of information that the system may capture, type of information that the system may use, etc.), social connections of the user (e.g., in a social network, at work, family), and so forth.

The community features 704 include information about other users and activities of the user related to other users, and may include community activities, identified biases in the community, trends in the community, news, opinions, recommendations, blogs, and so forth.

The user history features 706 include information about previous activities of the user, such as decisions previously made, activities of the user, identified biases, emails, shopping activities, entertainment activities, calendar of the user, question submitted by the user to the personal assistant, compromises by the user in view of a possible bias, collaborations of the user with other users, trust history of the user, and so forth.

The environment features 708 include information about the user's environment, such as a detected state of the user (e.g., angry, happy, stressed), states of other users near the user, social activities of the user, negotiations engaged by the user, social relations of the user, the weather where the user is located, travel information, financial state of the user, and so forth.

The knowledge base 710 includes the information captured by the personal assistant over time, and includes items such as known facts (e.g., derived from encyclopedias, reliable data sources, news outlets, scientific publications, training materials, etc.), opinions expressed by the user and by the community, decisions made by the user in the community, possible reasons for bias, identified behavior patterns in the user and the community, and so forth.

It is noted that the embodiments illustrated in FIG. 8 are examples and do not describe every possible embodiment. Other embodiments may utilize different features, fewer features, additional features, or any combination thereof. The embodiments illustrated in FIG. 8 should therefore not be interpreted to be exclusive or limiting, but rather illustrative.

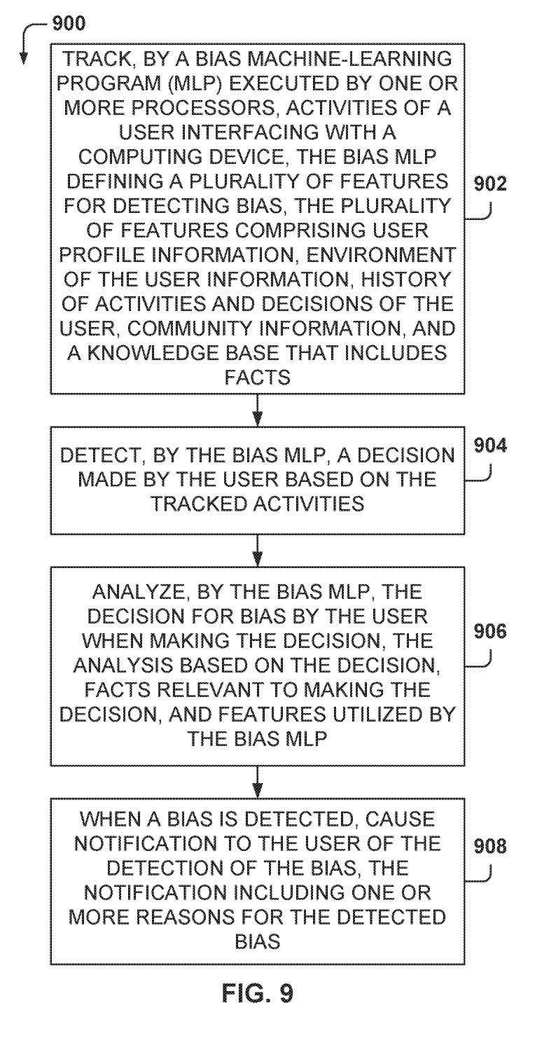

FIG. 9 is a flowchart of a method 900, according to some example embodiments, for notifying users of identified bias when the users make decisions. While the various operations in this flowchart are presented and described sequentially, one of ordinary skill will appreciate that some or all of the operations may be executed in a different order, be combined or omitted, or be executed in parallel.

Operation 902 is for tracking, by a bias MLP executed by one or more processors, activities of a user interfacing with a computing device. The bias MLP defines a plurality of features for detecting bias, where the plurality of features comprise user profile information, user environment information, history of activities and decisions of the user, community information, and a knowledge base that includes facts.

From operation 902, the method flows to operation 904 where the bias MLP detects a decision made by the user based on the tracked activities. At operation 906, the bias MLP analyzes the decision for bias by the user when making the decision. The analysis is on the decision, facts relevant to making the decision, and features utilized by the bias MLP.

From operation 906 the method flows to operation 908, and when a bias is detected, the bias MLP causes notification to the user of the detection of the bias, where the notification includes one or more reasons for the detected bias.

In one example, the method 900 further includes training the bias MLP with information regarding history of decisions by users, history of detected bias of users, a collection of facts pertaining to decisions made by users, outcomes associated with made decisions, bias detected in a community of users, responses of the user to identified biases, and one or more values associated with the features for detecting bias.

In one example, the method 900 further includes receiving a response of the user to the notification and re-training the bias MLP based on the response.

In one example, the method 900 further includes analyzing a previous decision made by the user (the previous decision including an estimate), detecting an outcome associated with the previous decision, and determining a bias on the previous decision when the estimate is different from the outcome.

In one example, the method 900 further includes providing a first option to the user for enabling detection of bias based on user history, a second option for enabling detection of bias based on common bias without tracking user information, and a third option for disabling detection of bias for the user. For example, the user may set the privacy settings to enable the use of user history data in order to analyze the user decisions and search for possible bias. The second option is for allowing the user to get bias-related suggestions, but without the use of personal information. This way, the bias MLP may not have as much information for detecting bias of the user, and rely instead on community data to identify possible bias.

In one example, the decision is associated with a negotiation and the method 900 further includes identifying biases for a party of the negotiation and providing a recommendation for the negotiation based on the identified biases for the party of the negotiation.

In one example, the detected biased is associated with a lack of understanding of all available options, where the notification includes one or more suggestions for additional options. For example, the user may believe that there are only two options for making the decision, but there may be more than two available options, and the bias MLP may let the user know about the additional options, even before a decision is made, if the bias MLP detects that the user is focused on only two options.

In one example, the user profile information includes name, title, location, education, work experience, privacy settings and connections of the user; and the environment of the user information includes a detected state of the user, social activities of the user and community, negotiations, user relations, and a financial state of the user.

In one example, the history of activities and decisions of the user includes user decisions, activities of the user, past biases of the user, emails, shopping, entertainment, calendar data, and past questions presented by the user.

In one example, the knowledge base further includes known facts, opinions expressed by the user and a community of users, decisions made by the community, bias reasons, and identified patterns related to bias decision making.

In one example, bias, when making a decision, refers to a belief held by a user that creates an obstacle for reaching the best decision.

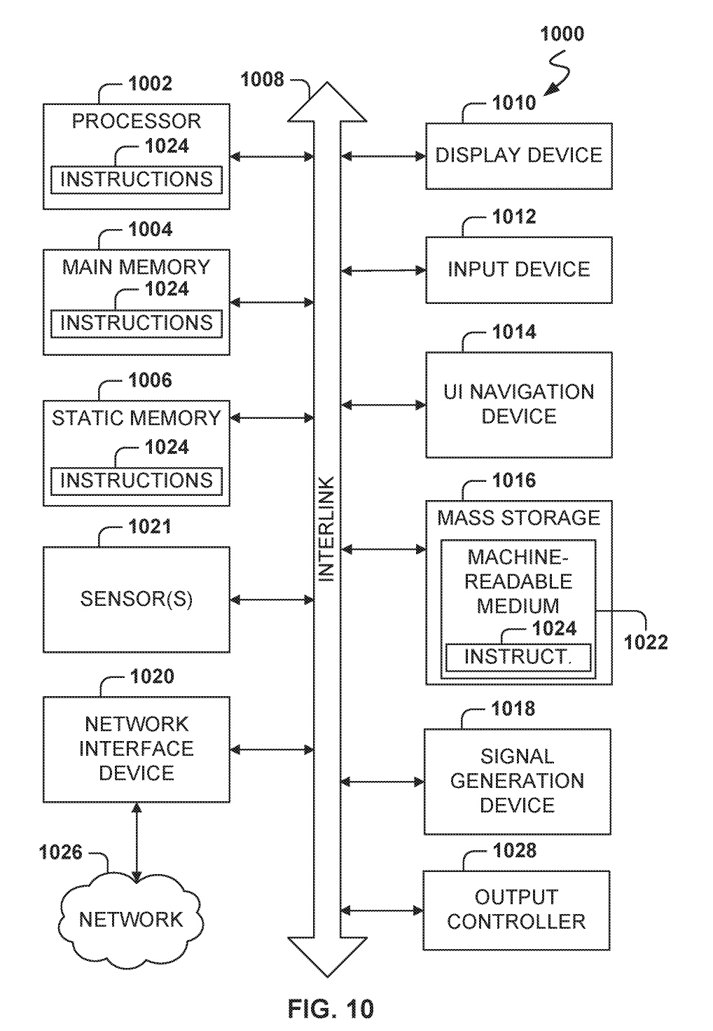

FIG. 10 is a block diagram illustrating an example of a machine upon which one or more example embodiments may be implemented. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a personal computer (PC), a tablet PC, a STB, a PDA, a mobile telephone, a web appliance, a network router, switch or bridge, or any machine capable of executing instructions (sequential or otherwise) that specify actions to be taken by that machine. Further, while only a single machine 1000 is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a display device 1010, an alphanumeric input device 1012 (e.g., a keyboard), and a UI navigation device 1014 (e.g., a mouse). In an example, the display device 1010, input device 1012, and UI navigation device 1014 may be a touchscreen display. The machine 1000 may additionally include a mass storage device (e.g., drive unit) 1016, a signal generation device 1018 (e.g., a speaker), a network interface device 1020, and one or more sensors 1021, such as a GPS sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1016 may include a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

While the machine-readable medium 1022 is illustrated as a single medium, the term “machine-readable medium” may include a single medium or multiple media (e.g., a centralized or distributed database, and/or associated caches and servers) configured to store the one or more instructions 1024.

The term “machine-readable medium” may include any medium that is capable of storing, encoding, or carrying instructions 1024 for execution by the machine 1000 and that causes the machine 1000 to perform any one or more of the techniques of the present disclosure, or that is capable of storing, encoding or carrying data structures used by or associated with such instructions 1024. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 1002.11 family of standards known as Wi-Fi®, IEEE 1002.16 family of standards known as WiMax®). IEEE 1002.15.4 family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions 1024 for execution by the machine 1000, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
tracking, by a bias machine-learning program (MLP) executed by one or more processors, activities of a user interfacing with a computing device, the bias MLP defining a plurality of features for detecting bias, the plurality of features comprising user profile information, user environment information, history of activities and decisions of the user, community information, and a knowledge base that includes facts;
detecting, by the bias MLP, a decision made by the user based on the tracked activities;
analyzing, by the bias MLP, the decision for bias by the user when making the decision, the analysis based on the decision, facts relevant to making the decision, and features utilized by the bias MLP; and
when a bias is detected, causing notification to the user of the detection of the bias, the notification including one or more reasons for the detected bias.

2. The method as recited in claim 1, further comprising:
training the bias MLP with information regarding history of decisions by users, history of detected bias of users, a collection of facts pertaining to decisions made by users, outcomes associated with made decisions, bias detected in a community of users, responses of the user to identified biases, and one or more values associated with the features for detecting bias.

3. The method as recited in claim 2, further comprising:
receiving a response of the user to the notification; and
re-training the bias MLP based on the response.

4. The method as recited in claim 1, further comprising:
analyzing a previous decision made by the user, the previous decision including an estimate;
detecting an outcome associated with the previous decision; and
determining a bias on the previous decision when the estimate is different from the outcome.

5. The method as recited in claim 1, further comprising:
providing a first option to the user for enabling detection of bias based on user history, a second option for enabling detection of bias based on common bias without tracking user information, and a third option for disabling detection of bias for the user.

6. The method as recited in claim 1, wherein the decision is associated with a negotiation, the method further comprising:
identifying bias for a party of the negotiation; and
providing a recommendation for the negotiation based on the identified biases for the party of the negotiation.

7. The method as recited in claim 1, wherein the detected biased is associated with a lack of understanding of all available options, wherein the notification includes one or more suggestions for additional options.

8. The method as recited in claim 1, wherein the user profile information includes name, title, location, education, work experience, privacy settings and connections of the user; wherein the environment of the user information includes a detected state of the user, social activities of the user and community, negotiations, user relations, and a financial state of the user.

9. The method as recited in claim 1, wherein the history of activities and decisions of the user includes user decisions, activities of the user, past biases of the user, emails, shopping, entertainment, calendar data, and past questions presented by the user; wherein the knowledge base further comprises known facts, opinions expressed by the user and a community of users, decisions made by the community, bias reasons, and identified patterns related to biased decision making.

10. The method as recited in claim 1, wherein bias when making a decision refers to a belief held by a user that creates an obstacle for reaching the best decision.

11. A system comprising:
a memory comprising instructions; and
one or more computer processors, wherein the instructions, when executed by the one or more computer processors, cause the one or more computer processors to perform operations comprising:
tracking, by a bias machine-learning program (MLP), activities of a user interfacing with a computing device, the bias MLP defining a plurality of features for detecting bias, the plurality of features comprising user profile information, user environment information, history of activities and decisions of the user, community information, and a knowledge base that includes facts;
detecting, by the bias MLP, a decision made by the user based on the tracked activities;
analyzing, by the bias MLP, the decision for bias by the user when making the decision, the analysis based on the decision, facts relevant to making the decision, and features utilized by the bias MLP; and
when a bias is detected, causing notification to the user of the detection of the bias, the notification including one or more reasons for the detected bias.

12. The system as recited in claim 11, wherein the instructions further cause the one or more computer processors to perform operations comprising:
training the bias MLP with information regarding history of decisions by users, history of detected bias of users, a collection of facts pertaining to decisions made by users, outcomes associated with made decisions, bias detected in a community of users, responses of the user to identified biases, and one or more values associated with the features for detecting bias.

13. The system as recited in claim 12, wherein the instructions further cause the one or more computer processors to perform operations comprising:
receiving a response of the user to the notification; and
re-training the bias MLP based on the response.

14. The system as recited in claim 11, wherein the instructions further cause the one or more computer processors to perform operations comprising:
analyzing a previous decision made by the user, the previous decision including an estimate;
detecting an outcome associated with the previous decision; and
determining a bias on the previous decision when the estimate is different from the outcome.

15. The system as recited in claim 11, wherein the instructions further cause the one or more computer processors to perform operations comprising:
providing a first option to the user for enabling detection of bias based on user history, a second option for enabling detection of bias based on common bias without tracking user information, and a third option for disabling detection of bias for the user.

16. A non-transitory machine-readable storage medium including instructions that, when executed by a machine, cause the machine to perform operations comprising:
tracking, by a bias machine-learning program (MLP), activities of a user interfacing with a computing device, the bias MLP defining a plurality of features for detecting bias, the plurality of features comprising user profile information, user environment information, history of activities and decisions of the user, community information, and a knowledge base that includes facts;
detecting, by the bias MLP, a decision made by the user based on the tracked activities;
analyzing, by the bias MLP, the decision for bias by the user when making the decision, the analysis based on the decision, facts relevant to making the decision, and features utilized by the bias MLP; and
when a bias is detected, causing notification to the user of the detection of the bias, the notification including one or more reasons for the detected bias.

17. The machine-readable storage medium as recited in claim 16, wherein the machine further performs operations comprising:
training the bias MLP with information regarding history of decisions by users, history of detected bias of users, a collection of facts pertaining to decisions made by users, outcomes associated with made decisions, bias detected in a community of users, responses of the user to identified biases, and one or more values associated with the features for detecting bias.

18. The machine-readable storage medium as recited in claim 17, wherein the machine further performs operations comprising:
receiving a response of the user to the notification; and
re-training the bias MLP based on the response.

19. The machine-readable storage medium as recited in claim 16, wherein the machine further performs operations comprising:
analyzing a previous decision made by the user, the previous decision including an estimate;
detecting an outcome associated with the previous decision; and
determining a bias on the previous decision when the estimate is different from the outcome.

20. The machine-readable storage medium as recited in claim 16, wherein the machine further performs operations comprising:
providing a first option to the user for enabling detection of bias based on user history, a second option for enabling detection of bias based on common bias without tracking user information, and a third option for disabling detection of bias for the user.
